(19) United States
(12) Patent Application Publication
(10) Pub. No.: US 2025/0029142 A1
(43) Pub. Date: Jan. 23, 2025

(54) METHOD EXECUTED BY TERMINAL DEVICE

(71) Applicant: TOYOTA JIDOSHA KABUSHIKI KAISHA, Toyota -shi (JP)

(72) Inventors: Yu NAGATA, Tokyo (JP); Takehira OTA, Inazawa-shi (JP); Daisuke TANIZAKI, Okazaki-shi (JP)

(73) Assignee: TOYOTA JIDOSHA KABUSHIKI KAISHA, Toyota -shi (JP)

(21) Appl. No.: 18/731,554

(22) Filed: Jun. 3, 2024

(30) Foreign Application Priority Data
Jul. 19, 2023 (JP) 2023-117846

(51) Int. Cl. G06Q 30/0207; G06F 3/16

(52) U.S. Cl. CPC G06Q 30/0239; G06F 3/167

(57) ABSTRACT

A method executed by a terminal device of a user, the method comprising: determining whether a vehicle has parked in a target area based on position information of a vehicle of the user; and displaying an image linked to content related to the target area on a screen of the terminal device of the user when it is determined that the vehicle has parked in the target area and the target area is within business hours.

### CROSS-REFERENCE TO RELATED APPLICATION

This application claims priority to Japanese Patent Application No. 2023-117846 filed on Jul. 19, 2023, incorporated herein by reference in its entirety.

### BACKGROUND

### 1. Technical Field

The present disclosure relates to a method executed by a terminal device.

### 2. Description of Related Art

Conventionally, a technology for providing a user with content related to a target area is known. For example, Japanese Unexamined Patent Application Publication No. 2003-346041 (JP 2003-346041 A) discloses an information processing device that displays a web page of a service area when the device detects that a vehicle has entered the service area.

### SUMMARY

There is room for improvement in the technology for providing the user with the content related to the target area.

In view of such circumstances, an object of the present disclosure is to improve a technology for providing a user with content related to a target area.

A method according to an embodiment of the present disclosure is a method executed by a terminal device of a user. The method includes:
determining, based on position information of a vehicle of the user, whether the vehicle has parked in a target area; and
displaying an image linked to content related to the target area on a screen of the terminal device of the user, when determination is made that the vehicle has parked in the target area and the target area is within business hours.

According to the embodiment of the present disclosure, the technology for providing the user with the content related to the target area is improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a schematic configuration of a system according to an embodiment of the present disclosure;

FIG. 2 is a block diagram illustrating a schematic configuration of a terminal device;

FIG. 3 is a block-diagram illustrating a schematic configuration of servers; and

FIG. 4 is a flow chart illustrating an operation of terminal device.

### DETAILED DESCRIPTION OF EMBODIMENTS

Hereinafter, an embodiment of the present disclosure will be described.

### Outline of Embodiment

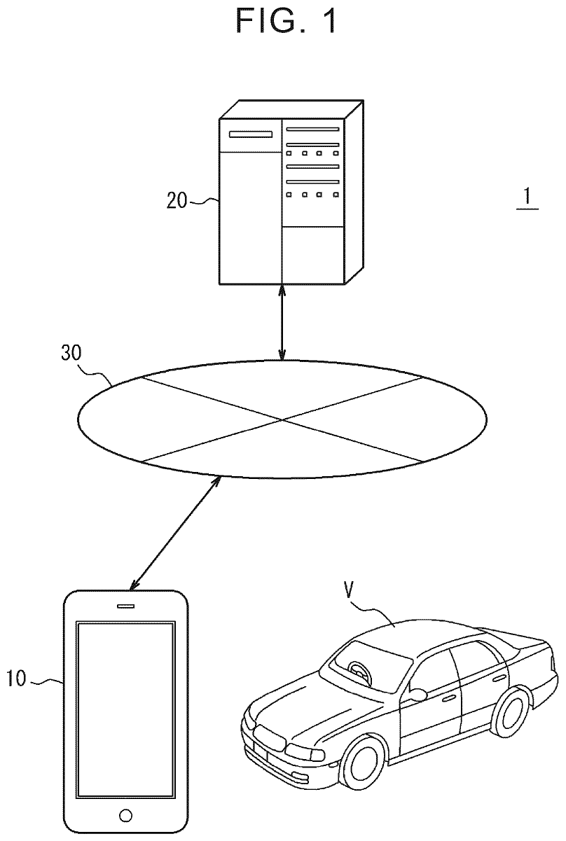

The outline of a system 1 according to an embodiment of the present disclosure will be described with reference to FIG. 1. The system 1 includes a terminal device 10 and a server 20. The terminal device 10 and the server 20 can communicate with each other via a network 30 including, for example, the Internet and a mobile communication network.

The terminal device 10 is, for example, a computer capable of installing and executing an application program such as a Personal Computer (PC), a mobile phone, a smart phone, or a tablet terminal. A dedicated application having a car navigation function is installed in the terminal device 10. Alternatively, the terminal device 10 is an Automotive navigation system provided in the vehicle V of the user. The terminal device 10 is used by a user. As will be described later, the terminal device 10 displays an image linked to the content related to the target area, and outputs synthesized speech.

The server 20 belongs to, for example, a cloud computing system or other computing system, and implements various functions. The server 20 can communicate with the terminal device 10 via the network 30.

Network 30 includes the Internet, at least one WAN, at least one MAN, or a combination thereof. “WAN” is an abbreviation for wide area network. “MAN” is an abbreviation for metropolitan area network. The network 30 may include at least one wireless network, at least one optical network, or a combination thereof. The wireless network is, for example, an ad hoc network, a cellular network, a wireless LAN, a satellite communication network, or a terrestrial microwave network. “LAN” is an abbreviation for local area network.

The vehicle V is a vehicle on which a user rides.

In the present embodiment, the user travels on a road such as an expressway (hereinafter, referred to as a “road or the like”) on the vehicle V. The user can use each target area on the traveling route of the vehicle V.

In addition, a dedicated application (hereinafter, referred to as a “coupon application”) for displaying coupons available in the target area is installed in the terminal device 10 of the user. The user can receive a service such as a discount at a predetermined facility in the target area by using the coupon application. In addition to the coupon display function, other functions may be implemented in the coupon application.

In the present embodiment, the “target area” refers to an area where the vehicle V can enter from a road or the like, and the user can park for a certain time in order to rest or to replenish energy to the vehicle V. The target area is, for example, a service area (SA) or a parking area (PA), but is not limited thereto. In the present embodiment, when the vehicle V enters the target area, the vehicle V travels on an approach road (deceleration lane) and parks in a parking lot. Further, in the present embodiment, a business time is set in the target area, and the user can use the coupon at a predetermined facility when the target area is within the business time.

In the present embodiment, “the vehicle V is parked in the target area” means that the vehicle V is parked in a predetermined place in the target area.

In the present embodiment, the “content relating to the target area” includes, but is not limited to, a web page of the target area, a download page of the coupon application, and a coupon list page (hereinafter, referred to as “specific page”) on the coupon application.

In the present embodiment, the “image linked to the content regarding the target area” is a banner image linked to the content regarding the target area. When the user touches the banner image displayed on the screen and selects the banner image, the terminal device 10 displays the link-destination web page or the like on the screen. The banner image may be in any other format, such as a button format.

In this embodiment, the “information about the target area” may include URL of web page of the target area and the link information to a particular page on the coupon application, such as a deep link. Hereinafter, the link information to the specific page on the coupon application is also referred to as “first information”. The information on the target area is stored in advance in the server 20, and can be arbitrarily changed.

In the present embodiment, the “first information” is link information to a specific page on the coupon application that displays coupons available in the target area. The first information is stored in the server 20 in advance, but may not be stored depending on the target area.

Here, an outline of the present embodiment will be described, and details will be described later. The terminal device 10 determines whether or not the vehicle V is parked in the target area based on the position information of the vehicle V of the user. When it is determined that the vehicle V is parked in the target area and the target area is within the business hours, the terminal device 10 displays an image linked to the content related to the target area on the screen of the terminal device 10 of the user.

According to the present embodiment, it is possible to easily transmit recommended information such as coupons, events, gourmet, and congestion information of the target area to the user who uses the target area. In addition, the recommended information can be safely transmitted by the user parking the vehicle in the target area and then transmitting the information. As described above, the technique of providing the content related to the target area to the user is improved in that the user who uses the target area can easily and safely grasp the recommended information of the target area.

Next, each component included in the system 1 will be described in detail.

### Configuration of Terminal Device

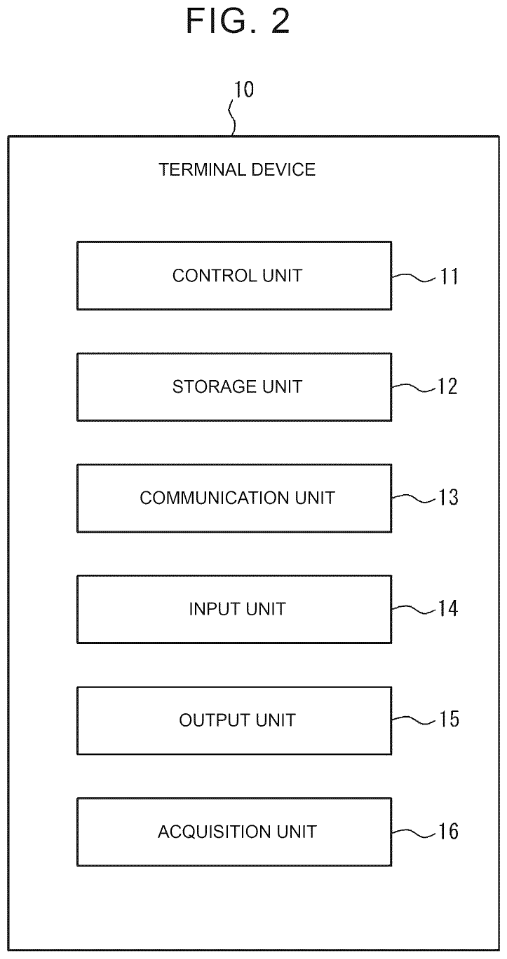

As illustrated in FIG. 2, the terminal device 10 includes a control unit 11, a storage unit 12, a communication unit 13, an input unit 14, an output unit 15, and an acquisition unit 16.

The control unit 11 includes one or more processors, one or more programmable circuits, one or more dedicated circuits, or a combination thereof. The processor may be, but is not limited to, a general-purpose processor such as, for example, Central Processing Unit (CPU) or Graphics Processing Unit (GPU), or a special-purpose processor specialized for a particular process. The programmable circuitry is, for example, but not limited to, Field-Programmable Gate Array (FPGA). The dedicated circuitry is, for example, Application Specific Integrated Circuit (ASIC), but is not limited thereto. The control unit 11 controls the overall operation of the terminal device 10.

The storage unit 12 includes one or more memories. The memories are, for example, a semiconductor memory, a magnetic memory, or an optical memory, but are not limited to these memories. Each memory included in the storage unit 12 may function as, for example, a main storage device, an auxiliary storage device, or a cache memory. The storage unit 12 stores optional information used for an operation of the terminal device 10. For example, the storage unit 12 may store a system program, an application program, map information, and the like. The information stored in the storage unit 12 may be updatable by, for example, information acquired from the network 30 via the communication unit 13.

The communication unit 13 includes one or more communication interfaces connected to the network 30. The communication interfaces correspond to a mobile communication standard such as 4th Generation (4G) and 5th Generation (5G), a wired LAN (Local Area Network) standard, or a wireless LAN standard, for example, but are not limited thereto, and may correspond to any communication standard. In the present embodiment, the terminal device 10 communicates with the server 20 via the communication unit 13 and the network 30.

The input unit 14 includes one or more input devices that detect an input operation by a user. The input device is, for example, a physical key, a capacitive key, a mouse, a touch panel, a touch screen integrally provided with a display of the output unit 15, a microphone, or the like, but is not limited thereto. Alternatively, the input unit 14 may include an interface for connecting an external input device.

The output unit 15 includes one or more output devices that output information. The output device is, for example, a display that outputs information by video, a speaker that outputs information by sound, or the like, but is not limited thereto. Alternatively, the output unit 15 may include an interface for connecting an external output device.

The acquisition unit 16 comprises a GPS receiver for receiving Global Positioning System (GPS) satellite-based GPS. The control unit 11 derives the position (for example, latitude and longitude) of the terminal device 10 based on GPS received by the acquisition unit 16.

### Server Configuration

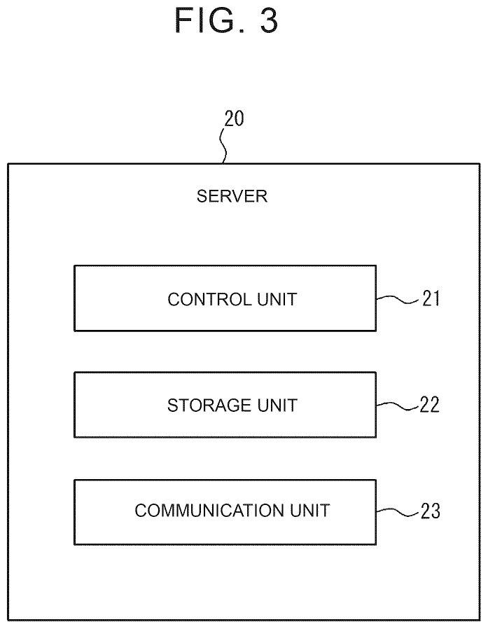

As illustrated in FIG. 3, the server 20 includes a control unit 21, a storage unit 22, and a communication unit 23.

The control unit 21 includes one or more processors, one or more programmable circuits, one or more dedicated circuits, or a combination thereof. The control unit 21 controls the overall operation of the server 20.

The storage unit 22 includes one or more memories. Each memory included in the storage unit 22 may function as, for example, a main storage device, an auxiliary storage device, or a cache memory. The storage unit 22 stores arbitrary information used for the operation of the server 20. For example, the storage unit 22 may store a system program, an application program, map information, embedded software, a database, and the like.

The communication unit 23 includes one or more communication interfaces connected to the network 30. The communication interfaces correspond to, for example, a mobile communication standard, a wired LAN standard, or a wireless LAN standard, but are not limited thereto, and may correspond to any communication standard.

In the present embodiment, the communication unit 23 can acquire the position information of the vehicle V by receiving the position information from the terminal device 10.

### Operation of Terminal Device

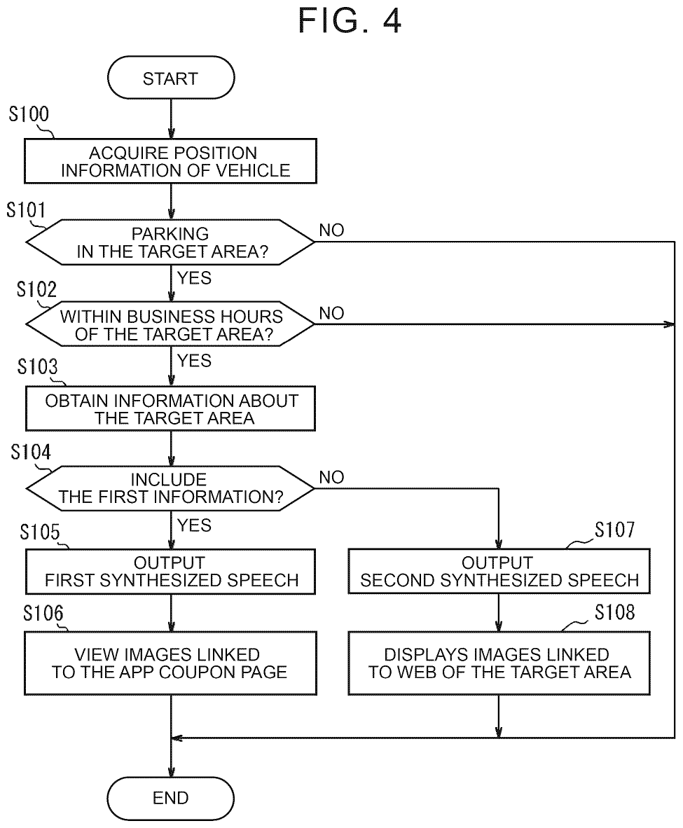

The operation of the terminal device 10 according to the present embodiment will be described with reference to FIG. 4. The operation in FIG. 4 corresponds to the method according to the present embodiment.

S100: The control unit 11 of the terminal device 10 acquires the position information of the vehicle V.

An arbitrary method can be adopted for acquiring the position information. For example, the control unit 11 acquires the position information of the vehicle V by the acquisition unit 16. The position information of the vehicle V may be specified by longitude and latitude.

The position information may be acquired at an arbitrary timing.

S101: The control unit 11 determines whether or not the vehicle V is parked in the target area. If it is determined that the vehicle has been parked (S101—Yes), the processing proceeds to S102. If it is determined that the vehicle is not parked (S101—No), the processing ends.

An arbitrary method can be adopted for determining whether or not the vehicle V has parked in the target area. For example, when the position information of the vehicle V indicates the site of the target area and the position of the vehicle V does not change for a certain period of time, the control unit 11 may determine that the vehicle V has parked in the target area. For example, in a case where the position information of the vehicle V indicates the site of the target area and does not change for 10 seconds, the control unit 11 may determine that the vehicle V has parked in the target area. On the other hand, when the position information of the vehicle V indicates the position on the main line, the control unit 11 may determine that the vehicle V is not parked in the target area. Further, even if the position information of the vehicle V indicates the inside of the site of the target area, if the position of the vehicle V is fluctuating, the control unit 11 may determine that the vehicle V is not parked in the target area.

S102: The control unit 11 determines whether it is within the business hours of the target area. If it is determined that it is within business hours (S102—Yes), processing proceeds to S103. If it is determined that it is out of business hours (S102—No), the processing ends.

An arbitrary method can be adopted for determining whether or not it is within the business hours. For example, the control unit 11 acquires information about the business hours of the target area, and determines whether or not the business hours of the target area are at the time of executing S102. The control unit 11 may acquire the information about the business hours of the target area in advance or may acquire the information at the time of executing S102. The information on the business hours of the target area may be acquired from, for example, an external server via the Internet, or the information input in advance to the server 20 may be acquired from the server 20.

S103: The control unit 11 acquires information about the target area.

An arbitrary method can be adopted for acquiring information on the target area. For example, the control unit 11 may acquire information about the target area from the external server via the Internet, or may acquire the information input in advance to the server 20 from the server 20. The control unit 11 may acquire the information about the target area in advance or may acquire the information at the time of executing S103.

S104: The control unit 11 determines whether or not the information regarding the target area includes the first information. If it is determined to include the first information (S104—Yes), processing proceeds to S105. If it is determined not to include the first information (S104—No), the processing proceeds to S107.

For example, the control unit 11 may execute S104 at the same time as acquiring the information on the target area in S103 to determine whether the first information is included.

S105: The control unit 11 outputs the first synthesized speech.

For example, the control unit 11 outputs, from the output unit 15, a message for guiding coupons available in the target area by synthesized speech. In addition, the control unit 11 may output a message to guide the user to select an image linked to a specific page on the coupon application, which will be described later.

S106: The control unit 11 displays an image linked to a particular page on the coupon application as the “image linked to the content related to the target area” described above.

For example, at the same time as outputting the first synthesized speech in S105, the control unit 11 displays images linked to a particular page on the coupon application on the map-screen of the terminal device 10. When the user selects an image, a specific page of the coupon application is displayed on the screen of the terminal device 10. Thus, the user can know the discount information and the like of the facility in the target area. Further, as described above, the user can receive a service such as a discount at a predetermined facility in the target area by using the coupon application.

S107: The control unit 11 outputs the second synthesized speech.

S107 is executed when it is determined that the information about the target area does not include the first information, i.e., the information about the coupon. Therefore, the control unit 11 outputs, from the output unit 15, the second synthesized speech having a content different from that of the first synthesized speech. For example, the control unit 11 may output a message that is guided to web page of the target area.

S108: The control unit 11 displays the image linked to web page of the target area as the “image linked to the content related to the target area” described above.

For example, at the same time as outputting the second synthesized speech in S107, the control unit 11 displays images linked to web pages of the target area on the map screen of the terminal device 10. When the user selects an image, a web page of the target area is displayed on the screen of the terminal device 10. Even when there is no coupon or the like available in the target area, the user can know the facilities or the like of the target area by looking at web page of the target area.

As described above, the terminal device 10 determines whether or not the vehicle V is parked in the target area based on the position information of the vehicle V of the user. When it is determined that the vehicle V is parked in the target area and the target area is within the business hours, the terminal device 10 displays an image linked to the content related to the target area on the screen of the terminal device 10 of the user.

According to this configuration, it is possible to easily transmit recommended information such as coupons, events, gourmet, and congestion information of the target area to the user who uses the target area. In addition, the recommended information can be safely transmitted by the user parking the vehicle in the target area and then transmitting the information. As described above, the technique of providing the content related to the target area to the user is improved in that the user who uses the target area can easily and safely grasp the recommended information of the target area.

Although the present disclosure has been described above based on the drawings and the embodiments, it should be noted that those skilled in the art may make various modifications and alterations thereto based on the present disclosure. It should be noted, therefore, that these modifications and alterations are within the scope of the present disclosure. For example, the functions or the like included in each component or each step or the like can be rearranged so as not to logically contradict each other, and a plurality of components or steps or the like can be combined or divided into one.

For example, in the above-described embodiment, on the assumption that the coupon application is installed in the terminal device 10, when it is determined that the information regarding the target area includes the first information (S104—Yes), the images linked to the particular page on the coupon application are displayed (S106). On the other hand, in the modified example, when the coupon application is not installed in the terminal device 10 and it is determined that the information regarding the target area includes the first information, the image linked to the download page of the coupon application may be displayed as an “image linked to the content regarding the target area”. In this case, the control unit 11 of the terminal device 10 may display the image linked to the download page of the coupon application on the screen of the terminal device 10. When the user selects an image, a download page of the coupon app may be displayed on the screen. At this time, the control unit 11 may display the image linked to web page of the target area together with the image linked to the download page of the coupon application.

Further, for example, in one modification of the above-described embodiment, in S101, the control unit 11 of the terminal device 10 may determine that the vehicle V has been parked in the target area at a time point when a predetermined time has elapsed since the vehicle V traveled on the approach road of the target area. For example, the control unit 11 may determine that the vehicle V has parked in the target area at a time point when 30 seconds have elapsed since the vehicle V traveled on the approach road of the target area.

Further, for example, in one modification of the above-described embodiment, the control unit 11 of the terminal device 10 may output, in S105 and/or S107, the information that the target area wants to guide the user, such as the event information performed in the target area, by the synthesized speech.

Further, for example, the server 20 may execute a part of the processing executed by the terminal device 10 in the above-described embodiment.

Further, an embodiment is also possible in which, for example, a general-purpose computer functions as the terminal device 10 according to the above embodiments. Specifically, a program describing processing contents for realizing each function of the terminal device 10 according to the above embodiments is stored in the memory of the general-purpose computer, and the program is read and executed by the processor. Therefore, the present disclosure can also be realized as a program that can be executed by the processor or a non-transitory computer-readable medium that stores the program.

What is claimed is:

1. A method executed by a terminal device of a user, the method comprising:
determining, based on position information of a vehicle of the user, whether the vehicle has parked in a target area; and
displaying an image linked to content related to the target area on a screen of the terminal device of the user, when determination is made that the vehicle has parked in the target area and the target area is within business hours.

2. The method according to claim 1, further comprising acquiring information on the target area, wherein the terminal device
outputs a first synthetic voice when the information on the target area includes first information on a coupon available in the target area, and
outputs a second synthetic voice when the information on the target area does not include the first information, content of the second synthetic voice being different from content of the first synthetic voice.

3. The method according to claim 2, wherein:
the first information on the coupon available in the target area is link information to a specific page on a dedicated application that displays the coupon available in the target area; and
when the information on the target area includes the first information and the dedicated application is installed in the terminal device, the image is an image linked to the specific page on the dedicated application.

4. The method according to claim 2, wherein, when the information on the target area includes the first information and a dedicated application is not installed in the terminal device, the image is an image linked to a download page of the dedicated application.

5. The method according to claim 2, wherein when the information on the target area does not include the first information, the image is an image linked to a web page of the target area.
